(19) United States
(12) Patent Application Publication
(10) Pub. No.: US 2008/0069250 A1
(43) Pub. Date: Mar. 20, 2008

(54) Multipath processing systems and methods

(75) Inventor: Chi-Ping Nee, Santee, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Conexant Systems, Inc.

(21) Appl. No.: 11/522,583

(22) Filed: Sep. 18, 2006

(51) Int. Cl. H04K 1/10

(52) U.S. Cl. 375/260

(57) ABSTRACT

Various embodiments of multipath processing systems and methods are disclosed. One method embodiment, among others, comprises the steps of providing a frequency domain channel response corresponding to a received signal, and applying a fast Fourier transform (FFT) on the frequency domain channel response to provide multi-path channel information.

### BACKGROUND

1. Technical Field

The present disclosure relates to systems and methods for processing signals in multipath communication systems.

2. Related Art

Communication networks come in a variety of forms. Notable networks include wireline and wireless. Wireline networks include local area networks (LANs), digital subscriber line (DSL) networks, and cable networks, among others.

Wireless networks include cellular telephone networks, classic land mobile radio networks and satellite transmission networks, among others. These wireless networks are typically characterized as wide area networks. More recently, wireless local area networks and wireless home networks have been proposed, and standards, such as Bluetooth and IEEE 802.11, have been introduced to govern the development of wireless equipment for such localized networks.

One popular communication technique includes orthogonal frequency division multiplexing (OFDM). OFDM finds application in a wide variety of communication systems encompassing both wired and wireless networks. When used in wired networks, OFDM is also referred to as a discrete multi-tone (DMT) technique. OFDM has been implemented in asymmetric digital subscriber lines (ADSL), high bit-rate digital subscriber lines (HDSL), and very high bit-rate digital subscriber lines (VDSL) in wired networks.

In wireless networks, OFDM is currently implemented in various broadcasting services such as digital audio broadcasting (DAB), digital video broadcasting—terrestrial (DVB-T), integrated services digital broadcasting—terrestrial (ISDB) and high-definition television broadcasting—terrestrial (HDTV). Further, OFDM is used in high-speed wireless LAN (HIPERLAN2) and high-speed wireless MAN (WiMax). Currently, specifications are being standardized as IEEE 802.11a and IEEE 802.11g for wireless LAN; and IEEE 802.16 for wireless MAN, based on OFDM communication techniques. In addition, applications of OFDM in fourth-generation (4G) mobile communication are also under investigation.

OFDM offers several advantages over other known digital communication techniques. For instance, OFDM improves spectral efficiency by implementing highly efficient utilization of the spectral band by closely spacing the sub-carriers used for communication. In addition, OFDM offers enhanced system capacity through optimal bit loading, which implies the assignment of different power and constellation sizes to each sub-carrier.

One challenge involved in communication systems in general is providing robustness against the effects of multipath propagation. In a wireless multipath propagation environment, signals travel along multiple paths of different lengths to reach a receiver. In wired environments, the propagated signal may be reflected multiple times before reaching its destination. Therefore, signals received in a multipath propagation environment comprise one or more direct signals and one or more delayed signals. For instance, when considering an OFDM communication system, due to the time delay between the direct signals and the delayed signals, received signal energy of the OFDM signal is spread in time. A signal with signal energy above a predefined threshold value is referred to as a significant signal. The time spread between the arrival of a first significant signal and a last significant signal is referred to as the multipath delay spread of the OFDM signal. The direct signals and the delayed signals interfere and distort the OFDM signal received at an OFDM receiver. The distortions introduced due to transmission through the multipath propagation environment are manifested in Rayleigh fading, frequency selective fading, and/or the delay spread of the OFDM signal. The delay spread causes inter-symbol interference (ISI), which may affect the bit-error rate of the OFDM signal and degrade the performance of the OFDM communication system. Therefore, it is important to eliminate the effects of multipath propagation to accurately extract the information in the OFDM signal or other types of signals.

Another challenge involved in implementing a communication system is to ascertain the time to start sampling data of interest (e.g., a symbol). For instance, OFDM communication systems are generally highly sensitive to timing and frequency offsets between a transmitter and a receiver. Therefore, it is important to accurately estimate timing and frequency offsets to ensure satisfactory performance of the OFDM communication system.

One known solution in OFDM systems, for instance, provides a technique that involves insertion of a guard interval (GI). The insertion of the guard interval helps in improving signal quality in spite of inter-symbol interference. However, this technique works properly only if the delay spread, Td, of the OFDM signal is less than the duration of the guard interval, Tg.

In light of the foregoing discussion, there is a need for systems and methods that can reduce the impact of the multipath propagation on the performance of communication systems.

### SUMMARY

Embodiments of multipath processing systems and methods are disclosed.

One system embodiment, among others, comprises receiver logic configured to provide a frequency domain channel response based on a received signal, and a fast Fourier transform (FFT) configured to provide multi-path channel information based on the frequency domain channel response.

One method embodiment, among others, comprises the steps of providing a frequency domain channel response corresponding to a received signal, and applying a fast Fourier transform (FFT) on the frequency domain channel response to provide multi-path channel information.

Other systems, methods, features, and advantages of the present disclosure will be or become apparent to one with skill in the art upon examination of the following drawings and detailed description. It is intended that all such additional systems, methods, features, and advantages be included within this description, and be considered within the scope of the present disclosure.

### BRIEF DESCRIPTION OF THE DRAWINGS

Many aspects of the disclosed systems and methods can be better understood with reference to the following drawings. The components in the drawings are not necessarily to scale, emphasis instead being placed upon clearly illustrating the principles of the disclosed systems and methods. Moreover, in the drawings, like reference numerals designate corresponding parts throughout the several views.

FIG. 1A is a block diagram illustrating a wireless multipath propagation environment in which various embodiments may be implemented.

FIG. 1B is a block diagram illustrating a wired multipath propagation environment in which various embodiments may be implemented.

FIG. 2 is a functional block diagram illustrating an embodiment of a multipath (MP) processing system as shown in FIGS. 1A and 1B.

FIG. 3 is a block diagram illustrating an embodiment of the multipath processing system shown in FIG. 2 as implemented in a receiver in an OFDM communication system.

FIG. 4A is a plot illustrating an exemplary frequency domain channel response generated by the multipath processing system shown in FIG. 3.

FIG. 4B is a plot illustrating exemplary multipath channel information generated on the basis of fast Fourier transforming the frequency domain channel response shown in FIG. 4A.

FIG. 5 is an MP processing method embodiment corresponding to the MP processing system shown in FIGS. 1A and 1B.

FIG. 6 is a flow diagram illustrating an MP processing method embodiment corresponding to the MP processing system shown in FIG. 3.

### DETAILED DESCRIPTION

Disclosed herein are various embodiments of multipath (MP) processing systems and methods (herein, simply MP processing systems unless noted otherwise). Such embodiments implement a fast Fourier transform (FFT) on a frequency domain channel response to provide multipath information that can be used to avoid (e.g., all or some) of the multipath interference in a received signal. For instance, the multipath information can be used by sampling logic in a receiver to adjust a sampling window in a manner that avoids adjacent channel interference in the time domain.

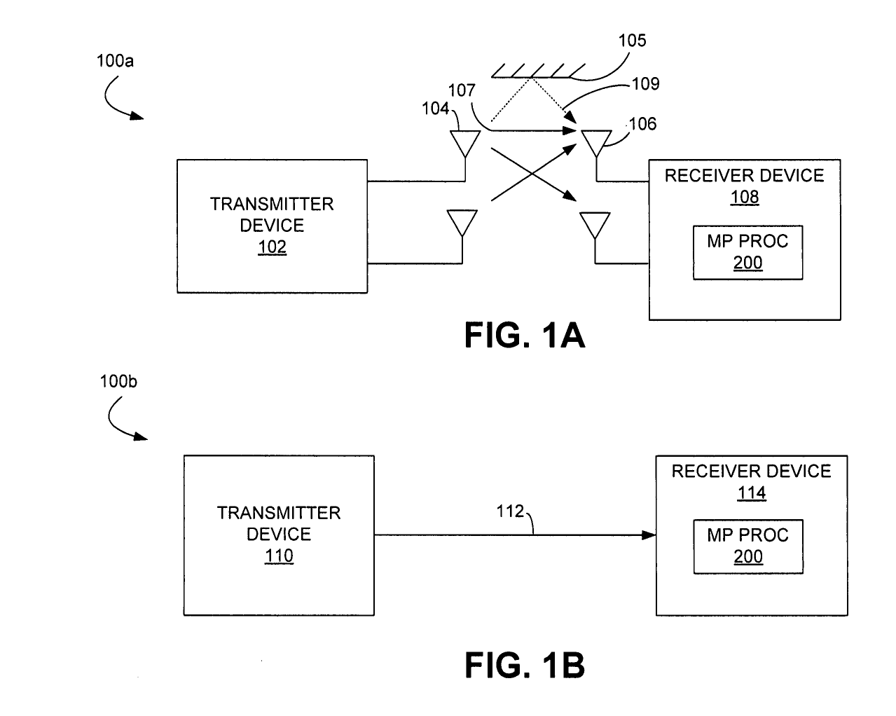

FIG. 1A is a block diagram illustrating a wireless multipath propagation environment 100a in which various embodiments of MP processing systems may be implemented. The multipath propagation environment 100a includes a transmitter device 102 comprising one or more antennas 104, a receiver device 108 comprising one or more antennas 106, and reflecting surfaces 105. The multipath propagation environment 100a further includes one or more direct signals 107 and one or more delayed signals 109. The transmitter device 102 is in communication (e.g., radio frequency communication) with the receiver device 108, the transmitter device 102 providing direct 107 and delayed signals 109 (e.g., due to the signal being reflected off surfaces such as reflecting surface 105) to the receiver device 108. The receiver device 108 comprises pre-processing logic (not shown) configured to filter and convert (e.g., analog-to-digital conversion) the received signals for use by the MP processing system 200. Direct signals 107 and delayed signals 109 are collectively referred to as multipath signals. Functionality of the transmitter device 102 and the receiver device 108 may be embodied in a single device (e.g., a transceiver), or segregated among two or more devices.

FIG. 1B is a block diagram illustrating a wired multipath propagation environment 100b in which various embodiments of MP processing systems 200 may be implemented. Such an environment 100b comprises a transmitter device 110 and a receiver device 114 coupled via a wired connection 112 (e.g., a cable connection, etc.). The receiver device 114 comprises pre-processing logic configured to filter and convert (e.g., analog-to-digital conversion) the received signals for use by the MP processing system 200. Functionality of the transmitter device 110 and the receiver device 114 may be embodied in a single device, or segregated among two or more devices. Multipath propagation may occur over the wired connection 112. The MP processing system 200, located in the receiver device 114 in one embodiment, avoids such multipath channel interference in a similar manner to the mechanisms described for the wireless embodiments.

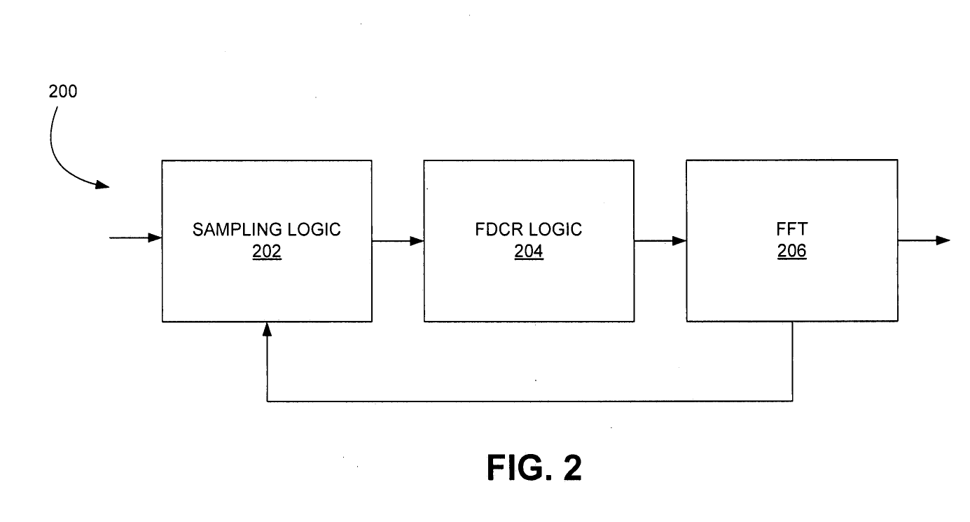

FIG. 2 is a functional block diagram that illustrates an embodiment of an MP processing system 200. As shown, the MP processing system 200 comprises sampling logic 202, frequency domain channel response (FDCR) logic 204, and a fast Fourier transform (FFT) logic 206 arranged in a loop configuration. In general, a signal is received at the sampling logic 202, which provides sampling functionality, such as extracting data of interest from a pre-processed signal corresponding to a received signal while avoiding all or some of the adjacent channel interference. Such extraction may be implemented by adjusting a sampling window, as described further below. The sampled signal is provided to the FDCR logic 204, which generates a frequency domain channel response (also referred to herein as multipath channel response) according to one of a variety of channel estimation mechanisms. The frequency domain channel response is provided to the FFT logic 206, which generates multipath channel information for use by the sampling logic 202 to avoid multipath interference when extracting data from a pre-processed signal corresponding to the received signal.

The MP processing system 200 as described above and hereinafter can be implemented in hardware, software, firmware, or a combination thereof. In the disclosed embodiment(s), a combination of hardware and software or firmware is implemented. With regard to software or firmware, the MP processing system 200 comprises one or more modules (e.g., code) that are stored in a memory and executed by a suitable instruction execution system. The one or more modules of the MP processing system 200 may comprise a program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

With regard to hardware, the MP processing system 200 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Additionally, the MP processing system 200 may be embodied in any wireless or wired communication device, including computers (desktop, portable, laptop, etc.), consumer electronic devices (e.g., multi-media players), compatible telecommunication devices, personal digital assistants (PDAs), or any other type of network devices, such as printers, fax machines, scanners, hubs, switches, routers, set-top boxes, televisions with communication capability, etc.

In view of the above description, a wireless orthogonal frequency domain multiplexing (OFDM) implementation for an embodiment of the MP processing systems 200 is described below to illustrate various aspects of the MP processing systems. Although described in the context of an OFDM system, such as found in current and future IEEE 802.11 standards, the scope of the various embodiments can be applied to, and thus include, other multiplexing techniques and/or wired or wireless standards. Additionally, although described in the context of a wireless multipath environment, one skilled in the art would understand within the context of this disclosure that the MP processing system 200 similarly applies to wired multipath environments.

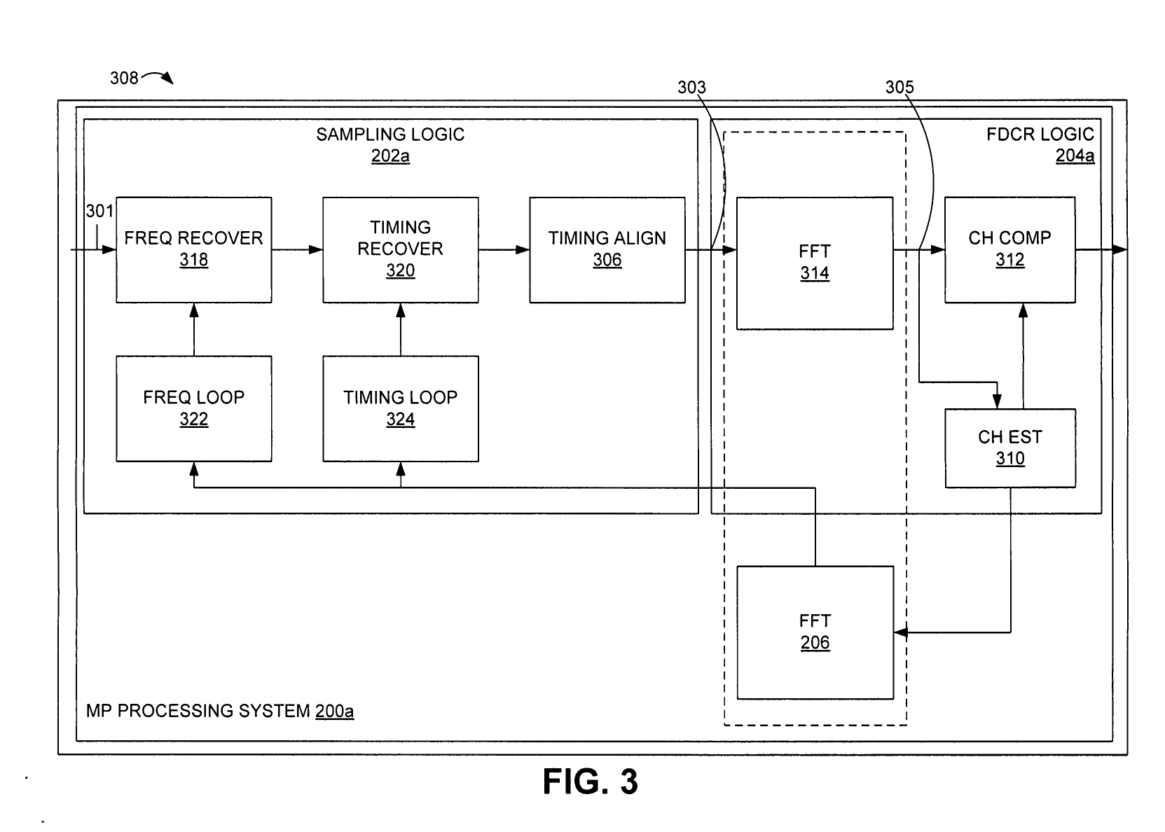

FIG. 3 is a block diagram illustrating an embodiment of an MP processing system 200a as implemented in a receiver 308 in an OFDM communication system. For instance, receiver 308 may correspond to receiver device 108 or may be embodied in a device with functionality corresponding to receiver device 108 and a transmitter device (such as transmitter device 102). The receiver 308 comprises MP processing system 200a. The MP processing system 200a comprises sampling logic 202a, frequency domain channel response (FDCR) logic 204a, and fast Fourier transform (FFT) logic 206. Although shown as separate modules, functionality of the MP processing system 200a may be combined into fewer or greater numbers of modules in some embodiments.

The sampling logic 202a comprises a frequency recovery unit 318, timing recovery unit 320, timing alignment unit 306, frequency loop 322, and timing loop 324. The FDCR logic 204a comprises fast Fourier transform (FFT) logic 314, channel estimation unit 310, and channel compensation unit 312. The FFT logic 206 may be a device separate from the FFT logic 314 in some embodiments, or functionality of the FFT logic 314 and FFT logic 206 may be implemented in the same device in some embodiments. For instance, the FFT logic 314 and 206 may be implemented in a single device (as represented by the dashed boundary) using auxiliary digital-switching circuits, among other mechanisms. Additionally, one embodiment of the FFT logic 314 and/or 206 comprises an N-point FFT unit corresponding to N sub-carriers in an OFDM signal. In general, the receiver 308 comprises functionality responsible for filtering and demodulating the received signals, and generally, functionality responsible for performing processing that is complementary to the processing performed at a transmitting device. Additional processing, not shown, may include signal separation, in-phase/quadrature (I/Q) signal determination, cyclic extension (e.g., guard interval or GI) removal, among other well-known receive functionality.

In one exemplary operation, signals (e.g., OFDM multipath signals) are received at one or more antennas (e.g., antennas not shown, but similar to antennas 106 of FIG. 1A) of the receiver 308 and processed by one or more stages (e.g., pre-processing logic, not shown in the figure) responsible for filtering and converting (e.g., analog-to-digital conversion, conversion to baseband, etc.) the received signals.

The sampling logic 202a identifies a symbol boundary and extracts a symbol from the processed (i.e., processed in the one or more initial stages of the receiver 308) signal(s) 301 (hereinafter, simply signal for brevity), as well as estimates any carrier-frequency offsets and provides timing alignment. The FDCR logic 204a receives signal 303 from the sampling logic 202a and performs an FFT operation on the signal 303 to transform the signal 303 from a time-domain to a frequency-domain, thereby generating frequency-domain signal 305. It would be understood by those having ordinary skill in the art that other mechanisms for providing a frequency domain signal may be used in some embodiments (e.g., not limited to using FFT logic). The channel estimation unit 310 samples a series of pilot signals in the frequency-domain signal from the FFT logic 314 and generates a multipath channel response. In some embodiments, alternative mechanisms for providing a reference signal (e.g., in lieu of or in addition to pilot signals) may be used to provide a multipath channel response. The channel-estimation unit 310 provides the multipath channel response to the channel compensation unit 312. The channel-compensation unit 312 compensates the frequency domain signal 305 received from the FFT logic 314, based on the multipath channel response, for provision to a demodulating unit (not shown in the figure), where it is further processed to extract information data.

The channel estimation unit 310 also provides the multipath channel response to the FFT logic 206. The FFT logic 206 performs an FFT operation on the multipath channel response and generates multipath channel information. Such multipath channel information may include information related to signal strength, phase and/or relative delays of multipath signals received at the receiver 308 (e.g., similar to direct signals 107 and delayed signals 109). In one embodiment, the multipath channel information is provided to the frequency loop 322 and the timing loop 324 of the sampling logic 202a. The frequency loop 322 and the timing loop 324 provides control signals to the frequency recovery unit 318 and the timing recovery unit 320, respectively, to synchronize bit timing and sample timing for extracting a symbol from the signal 301.

Now that a general description of operation is provided of the MP processing system 200a, attention is directed to various features of the MP processing system 200a in further detail. With regard to an embodiment of the sampling logic 202a, the description that follows presents further detail on how multipath channel information is utilized in implementing sampling functionality. The frequency loop unit 322 regulates bit-timing offset correction in the frequency recovery unit 318. In one embodiment, the frequency loop unit 322 identifies from the multipath channel information a multipath signal with the greatest signal strength, hereinafter referred to as the strongest multipath signal. The signal strength of the strongest multipath is denoted as |P(p)|.

The frequency loop unit 322 further identifies, from the multipath channel information, multipath signals that exceed a predefined ratio of the signal strength of the strongest path. The strongest signal and other multipath signals identified by the frequency loop unit 322 are hereinafter collectively referred to as significant multipath signals. In one embodiment, frequency loop unit 322 subsequently selects a predetermined, programmable number of significant multipath signals from the significant multipath signals identified, based on the relative signal strength of the identified significant multipath signals. If the number of significant multipath signals is less than the predetermined number, then all of the significant multipath signals are selected. The frequency loop unit 322 determines the locations of the significant multipath signals from the multipath channel information and generates an error metric, based on the correlation between the symbols of each significant multipath signal. In one embodiment, an energy metric ‘E’ is calculated for each path, where E is defined as:

E=Σ[|P(p−1)|−|P(p+1)]*|P(p)| Equation (I)

wherein P represents signal energy, p represents the strongest multipath signal, (p−1) represents a preceding multipath signal, and (p+1) represents a succeeding multipath signal.

An error metric for frequency loop unit 322 is calculated by the frequency loop unit 322, based on the difference between the value of the energy metric, E, of a given symbol and the value of E of the succeeding symbol of each significant multipath signal identified from the multipath channel information.

In one embodiment, based on the value of the error metric, the frequency loop unit 322 determines the positioning of a sampling window. Therefore, the frequency recovery unit 318 samples the signal 301 to extract a symbol by suitably positioning a sampling window under the control of the frequency loop unit 322. In one embodiment, the frequency loop unit 222 is implemented by using a phase-locked loop (PLL), although one skilled in the art would understand that other mechanisms with like-functionality to a PLL can similarly be employed.

The timing loop unit 324 regulates sample timing offset correction in the timing recovery unit 320 to accurately resolve the start of a symbol boundary in a suitable significant multipath signal. The start of a symbol boundary is also referred to as the leading end of the symbol. A suitable multipath signal is selected from the significant multipath signals by using the frequency loop unit 322. The timing loop unit 324 determines a start-point for recovery from the symbol provided by the frequency recovery unit 318. The timing recovery unit 320 starts the recovery of the symbol from the start-point indicated by the timing loop unit 324. The timing recovery unit 320 further buffers symbol information from a significant multipath signal with a signal strength immediately next to the strongest significant multipath signal. The buffering is performed from the beginning of the symbol, as extracted using the frequency recovery unit 318, until the start-point from the strongest significant multipath signal starts. The buffered portion is appended to the information extracted from the strongest significant multipath signal. In one embodiment, the timing loop unit 324 is implemented by using a phase locked loop (PLL), although one skilled in the art would understand that other mechanisms with like-functionality to the PLL can similarly be employed.

Note that the sampling logic 202a includes functionality to estimate and remove carrier-frequency offset as well as carrier-phase offset between a carrier of the signal 301 and a local oscillator (not shown). Frequency alignment is carried out by frequency loop unit 322, which estimates carrier-frequency offset to preserve mutual orthogonality between the sub-carriers of the OFDM signal. The OFDM signal received at receiver 308 may suffer from carrier-frequency offset. Carrier-frequency offset results in the sub-carriers of the OFDM signal being shifted in a frequency-domain, thereby compromising the mutual orthogonality between the sub-carriers of the OFDM signal. Frequency-loop unit 322 utilizes one of a plurality of carrier-frequency offset-estimation algorithms to estimate the carrier-frequency offset in the OFDM signal. Frequency-loop unit 322 provides control signals to frequency recovery unit 318. In one embodiment, frequency-loop unit 322 utilizes digital signal processing to correct the carrier-frequency offset in the OFDM signal.

Note that the timing alignment unit 306 comprises well-known timing alignment functionality, and thus the discussion of the same is omitted for brevity.

Having described features of an embodiment of the sampling logic 202a, attention is now directed to various features of an embodiment of the FDCR logic 204a. The channel estimation unit 310 performs a dynamic estimation of a multipath channel response, and therefore carries out initial training and dynamic tracking for the receiver 308. In one implementation, the receiver 308 is used in a frequency-selective and time-varying multipath channel. Therefore, the receiver 308 can dynamically estimate the multipath channel response in real time. In one embodiment, the channel estimation unit 310 estimates the multipath channel response in the frequency-domain for each of the sub-carriers, hence generating the frequency-domain multipath channel response. For instance, the channel estimation unit 310 generates an estimate of the multipath channel response using one of a plurality of training-based algorithms. Training-based algorithms typically generate an estimate of the multipath channel response based on a set of reference values included in the OFDM signal received at the receiver 308. The set of reference values may comprise pilot signals or other training signals. Examples of well-known training-based algorithms include a minimum mean square error (MMSE) algorithm, a least square (LS) algorithm, a maximum likelihood (ML) algorithm, among others.

The channel estimation unit 310, in one embodiment, generates a pilot interpolation curve, which represents an estimate of the multipath channel response estimate. In some embodiments, the channel estimation unit 310 generates an estimate of the multipath channel response using one of a plurality of blind algorithms. Blind algorithms typically generate an estimate of the multipath channel response using differential methods that exploit knowledge pertaining to one or more properties of the symbols containing the information data in the OFDM signal received at the receiver 308. In some embodiments, the channel estimation unit 310 generates an estimate of the multipath channel response using one of a plurality of semi-blind algorithms, where training signals as well as differential methods are employed to generate the multipath channel response estimate. One having ordinary skill in the art would understand that one or a combination of these and/or other mechanisms for generating an estimate of the frequency domain channel response can be used in some embodiments.

In one embodiment, the channel compensation unit 312 multiplies the OFDM symbol for each sub-carrier with the respective transfer functions of the multipath channel, as predicted by channel estimation unit 310, to compensate for the effects of the multipath propagation environment (e.g., environment 100a) on an OFDM signal.

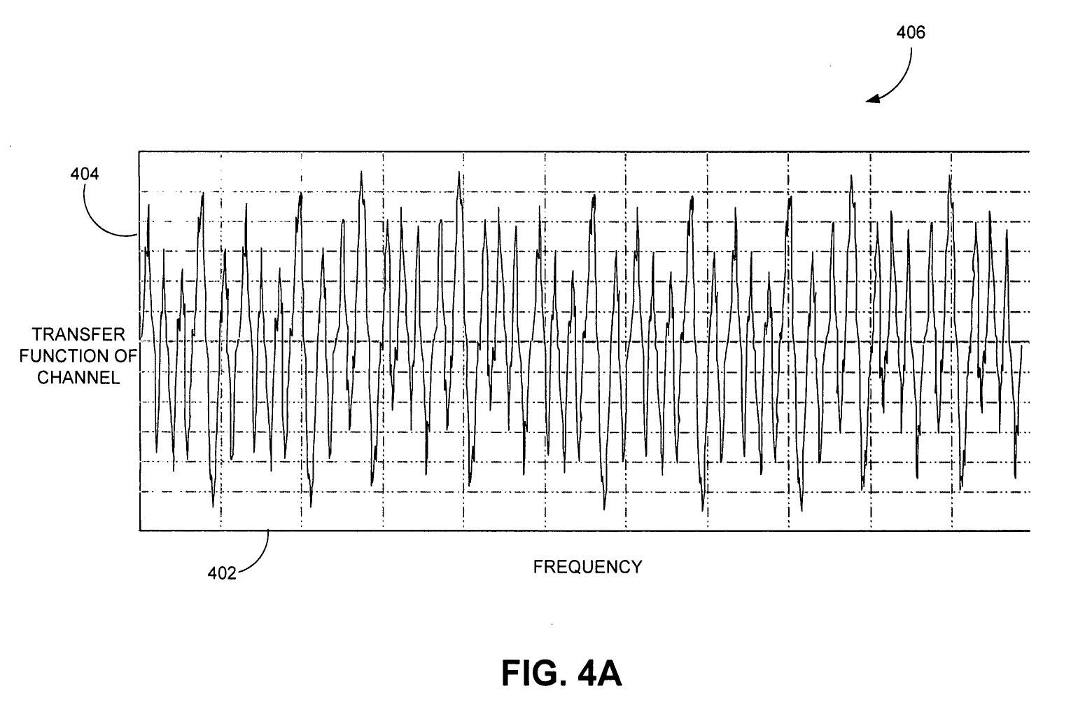

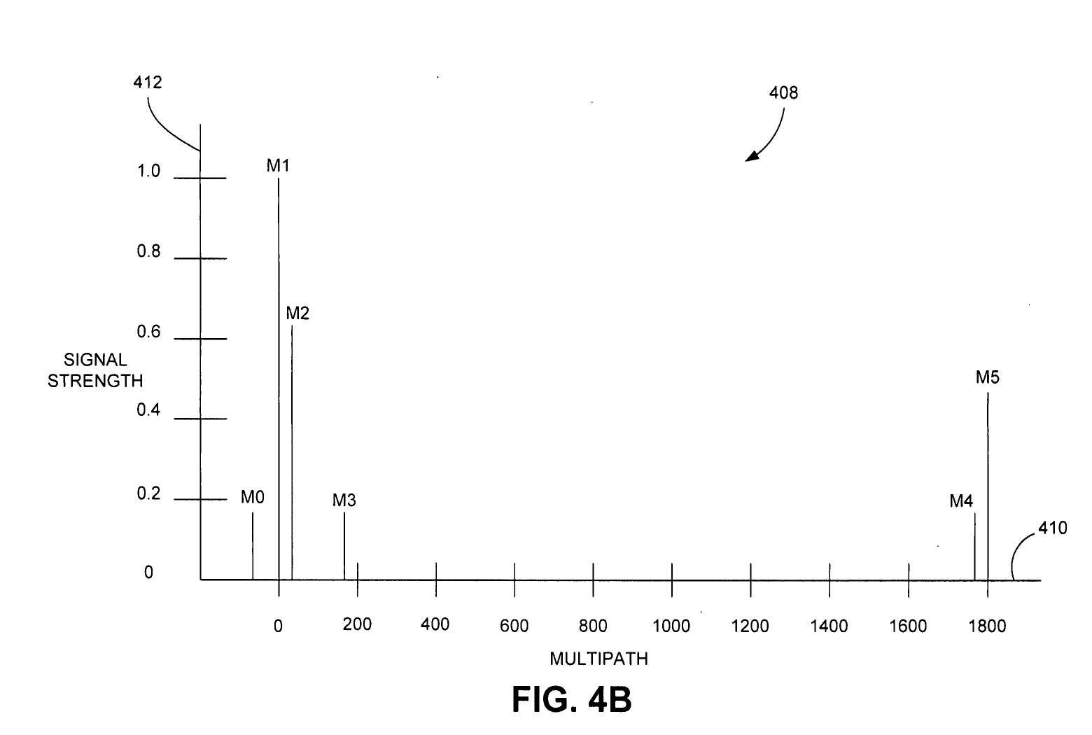

FIG. 4A is a plot illustrating an estimate of an exemplary multipath channel response presented in the form of a pilot interpolation curve 406, though not limited to such a mechanism. The plot depicts the sub-carrier frequency plotted on the x-axis 402 and the signal strength plotted on the y-axis 404. The estimate of the multipath channel response 406 depicts variations of the signal strength of sub-carriers with the frequencies of the sub-carriers. In the example illustrated in FIG. 4A, the pilot interpolation curve 406 is generated by using one of a plurality of training-based algorithms as described above.

FIG. 4B is a plot illustrating exemplary multipath channel information presented in the form of a multipath channel profile 408, though not limited to such a mechanism. The plot depicts the path plotted on the x-axis 410 and the signal strength plotted on the y-axis 412. The multipath channel profile 408 depicts paths M0, M1, M2, M3, M4, and M5, all but one which the sampling logic 202a seeks to avoid. In the plot, the path at 0 represents a location where the frequency recovery unit 318 places the sampling window, since it represents the location having the highest signal strength. The sampling logic 202a uses such multipath channel information (e.g., multipath channel profile 408) to select a sampling window that avoids multipath channel interference, and thus by selecting the sampling window at path 0 (M1) for this example, the other paths are avoided. Multipath signals such as M0, which arrive before the sampling window, are referred to as pre-echoes. Similarly, signals that arrive after the strongest multipath signal M1 are referred to as post-echoes. The multipath channel profile 408 includes information related to the signal strength, phase and relative time delays of the multipath signals in the received OFDM signal. The following equation mathematically describes the signal strength of each sub-carrier:

S₍ⱼ₎=aᵢ*e^{jφ}i=1, 2, . . . N sub-carriers Equation (II)

wherein Sᵢ is the signal-strength vector of i^{th} sub-carrier, aᵢ is the magnitude of the signal-strength vector, and φ is the phase of the signal-strength vector.

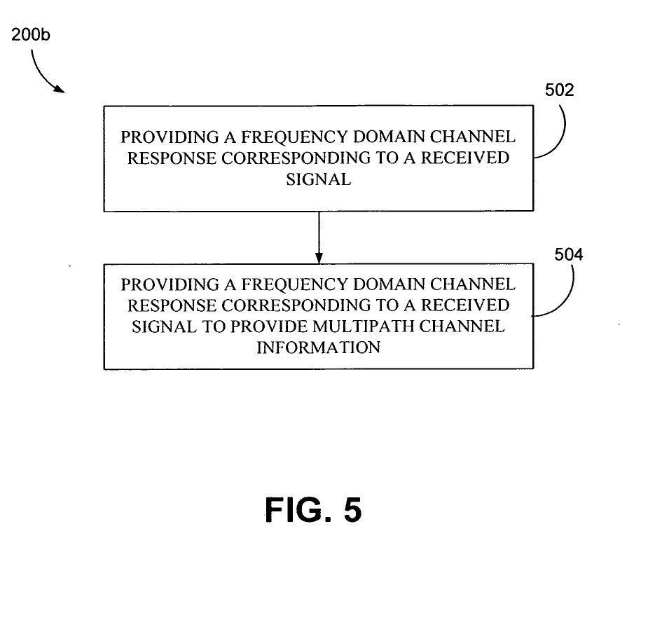

In view of the above description, it will be appreciated that one MP processing method embodiment 200b for processing a signal in a multipath environment 100a, 100b, as illustrated in FIG. 5, comprises providing a frequency domain channel response corresponding to a received signal (502), and applying a fast Fourier transform (FFT) on the frequency domain channel response to provide multi-path channel information (504).

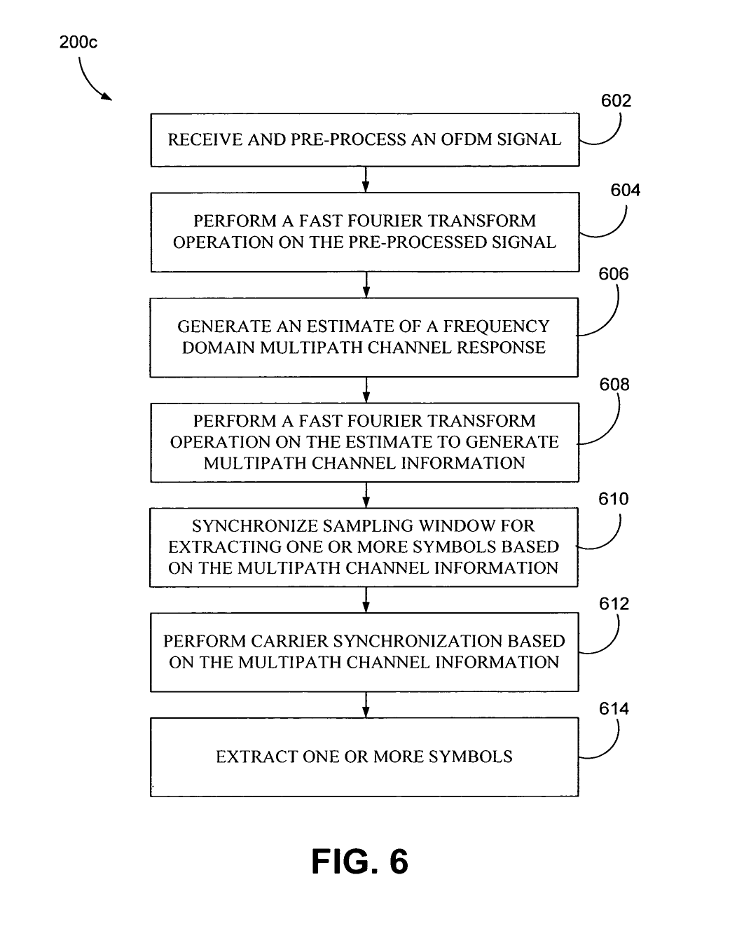

With regard to the exemplary OFDM implementation described above, FIG. 6 is a flow diagram illustrating an MP processing method embodiment 200c that processes an OFDM signal in an OFDM communication multipath environment.

At 602, an OFDM signal is received and pre-processed (e.g., down converted to a baseband range, converted from analog to digital and subjected to such initial processing) as may be necessary to make the OFDM signal suitable for being further processed.

At 604, an FFT operation is performed on the pre-processed signal (e.g., signal 303). For instance, the FFT logic 314 transforms the pre-processed signal from a time-domain to a frequency-domain, thereby generating a frequency-domain signal (e.g., signal 305). In one embodiment, the multipath signals are mathematically represented by the following equations:

y(n)=x(n)+a₁x(n−τ₁)+a₂x(n−τ₂)+a₃x(n−τ₃)+ . . . +a₁x(n+τ₋₁)+a₂x(n+τ₋₂).

Y(k)=FFT [y(n)]=X(k)[1+a₁W_{N}^{kτ1}+a₂W_{N}^{kτ2}+ . . . +a₁W_{N}^{kτ-1}+a₋₁W_{N}^{kτ-1} . . . ],

where W_{N}=exp(−2Πj/N), and y(n) is the time-domain OFDM signal received at the receiver (e.g., receiver 308); x(n), x(n−τ₁) and a₋₁x(n+τ₋₁) are a direct signal, post-echoes and pre-echoes, respectively; a is the attenuation effected on a multipath signal; τ₁, τ₂, and so on, are the respective time delays of the multiple path signals.

Similarly, Y(k) is the frequency-domain signal and, X(k) a frequency-domain direct path. N is the total number of sub-carriers in the received OFDM signal.

At 606, an estimate of the frequency-domain multipath channel response is generated, based on one of a plurality of channel response estimation algorithms. The estimate of the frequency-domain multipath channel response predicts the transfer function of each sub-carrier, as explained by the following mathematical equations:

Y(k)=X(k)H(k)

H(k)=1+a₁W_{N}^{kτ1}+a₂W_{N}^{kτ2}+ . . . +a₋₁W_{N}^{kτ-1}+a₋₁W_{N}^{kτ-1} . . . ,

where H(k) defines the transfer function of the multipath channel for each sub-carrier in the received OFDM signal.

At 608, an FFT operation is performed on the frequency-domain multipath channel response (e.g, on the estimate) to generate multipath channel information (e.g., multipath channel profile), as described mathematically by the following equations:

P(n)=FFT[H(k)]=FFT[1+a₁W_{N}^{kτ1}+a₂W_{Nτ2}+ . . . +a₋₁W_{N}^{kτ-1}+a₋₁W_{N}^{kτ-1} . . . ]

P(n)=1+a₁δ(1+τ₁)+a₂δ(1+τ₂)+a₃δ(1+τ₃)+ . . . +a₋₁δ(1+τ₋₁)+a₋₂δ(1+τ₋₂),

where δ(n)=0 for n=0 and δ(n)≠0 for n≠0.

Therefore, in one embodiment, the multipath channel profile P(n) is represented as a series of impulses with relative path locations.

At 610, a sampling window is synchronized based on the multipath channel information (e.g., multipath channel profile) generated at 608. Synchronizing the sampling window includes performing a first level of synchronization to position the sampling window and a second level of synchronization to determine a start-point within the sampling window. The start-point is the point from where the extraction is started for the symbol obtained by using the sampling window.

At 612, carrier synchronization is performed. Carrier synchronization includes removing carrier-frequency offset and carrier-phase offset from the OFDM signal. Carrier synchronization is performed using the multipath channel information (e.g., profile) as well as one of a plurality of carrier-frequency offset algorithms.

At 614, symbol data is extracted from the OFDM signal, based on the sampling window obtained at 610. The symbol data is extracted starting from the start-point determined at 610. The sampling window data located before the start-point is buffered and appended to the symbol extracted by using the start-point as a reference. The symbols are then demodulated in accordance with one of a plurality of demodulation techniques.

The flow diagrams of FIGS. 5 and 6 show the architecture, fimctionality, and/or operation of a possible implementation of the MP processing methods 200b and 200c, respectively. In this regard, each block may represent a module, segment, or portion of code, which comprises one or more executable instructions for implementing the specified logical finction(s). It should also be noted that in some alternative implementations, the finctions noted in the blocks may occur out of the order noted in FIGS. 5 and 6. For example, two blocks shown in succession in FIGS. 5 and 6 may in fact be executed substantially concurrently or the blocks may sometimes be executed in the reverse order, depending upon the functionality involved, as will be further clarified hereinbelow.

Certain embodiments of the multipath processing systems 200 (e.g., 200a-200c) disclosed herein improve the processing of signals in various multipath environments. The multipath channel information comprises information related to the amplitude, phase and relative delay of one or more direct signals and one or more delayed signals, and provides an improved prediction of channel behavior. Such disclosed embodiments improve sampling-window synchronization, which may reduce inter-symbol interference (ISI). The multipath channel information also reduces the effect of phase noise in synchronization loops such as the PLL, thereby enabling improved carrier synchronization. Therefore, various embodiments of the MP processing systems 200 may improve the performance of the communication systems under adverse multipath channel conditions.

While various embodiments of MP processing systems 200 have been illustrated and described, it will be clear that these and other embodiments are not limited to the above description. Numerous modifications, changes, variations, substitutions and equivalents will be apparent to those skilled in the art without departing from the spirit and scope of the present disclosure as described in the claims.

Therefore, at least the following is claimed:

1. A method, comprising:
providing a frequency domain channel response corresponding to a received signal; and
applying a fast Fourier transform (FFT) on the frequency domain channel response to provide multi-path channel information.

2. The method of claim 1, further comprising using the multi-path channel information to avoid adjacent channel interference corresponding to the received signal.

3. The method of claim 2, wherein using comprises adjusting a sampling window position based on the multi-path channel information to extract data of interest corresponding to the received signal.

4. The method of claim 3, wherein adjusting a sampling window position comprises adjusting the sampling window position based on an error metric derived from the multi-path channel information, the error metric based on a derived energy metric corresponding to a desired multipath signal and other multipath signals.

5. The method of claim 2, wherein using comprises determining a start point to extract data of interest corresponding to the received signal based on the multi-path channel information.

6. The method of claim 1, further comprising extracting data of interest based on the multi-path channel information while avoiding adjacent channel interference.

7. The method of claim 1, further comprising receiving multipath signals corresponding to the received signal over a wired connection.

8. The method of claim 1, further comprising wirelessly receiving multipath signals corresponding to the received signal.

9. A system, comprising:
frequency domain channel response logic configured to provide a frequency domain channel response based on a received signal; and
a fast Fourier transform (FFT) logic configured to provide multi-path channel information based on the frequency domain channel response.

10. The system of claim 9, further comprising sampling logic configured to use the multi-path channel information to avoid adjacent channel interference corresponding to the received signal.

11. The system of claim 10, wherein the sampling logic is further configured to adjust a sampling window based on the multi-path channel information to extract data of interest corresponding to the received signal.

12. The system of claim 11, wherein the sampling logic is further configured to adjust a sampling window based on a error metric derived from the multi-path channel information, the error metric based on an energy metric corresponding to a desired multipath signal and other multipath signals derived by the sampling logic.

13. The system of claim 10, wherein the sampling logic is further configured to determine a start point to extract data of interest corresponding to the received signal based on the multi-path channel information.

14. The system of claim 10, wherein the sampling logic is configured to extract data of interest based on the multi-path channel information while avoiding adjacent channel interference.

15. The system of claim 10, further comprising pre-processing logic coupled to the sampling logic, the pre-processing logic configured to receive multipath signals corresponding to the received signal over a wired connection.

16. The system of claim 10, further comprising pre-processing logic coupled to the sampling logic, the pre-processing logic configured to receive multipath signals corresponding to the received signal over a wired connection.

17. A system, comprising:
means for generating a frequency domain channel response corresponding to a received signal; and
means for applying a fast Fourier transform (FFT) on the frequency domain channel response to provide multi-path channel information.

18. The system of claim 17, wherein the means for generating comprises sampling logic.

19. The system of claim 17, wherein the means for generating comprises a FFT logic and channel estimation unit.

20. The system of claim 17, wherein the means for applying comprises a FFT logic.

21. The system of claim 17, further comprising means for sampling configured to use the multi-path channel information to avoid adjacent channel interference corresponding to the received signal while extracting data of interest corresponding to the received signal.

22. The system of claim 21, wherein the means for sampling comprises a phase-locked loop.

23. The system of claim 21, wherein the means for sampling, the means for generating, and the means for applying comprises hardware, software, or a combination of hardware and software.

24. The system of claim 21, wherein the means for sampling, the means for generating, and the means for applying are disposed in a wireless communications device or a wired communications device.
